(19) United States
(12) Patent Application Publication
(10) Pub. No.: US 2017/0043402 A1
(43) Pub. Date: Feb. 16, 2017

(54) METHOD FOR THE PRODUCTION OF PARTS MADE FROM METAL OR METAL MATRIX COMPOSITE AND RESULTING FROM ADDITIVE MANUFACTURING FOLLOWED BY AN OPERATION INVOLVING THE FORGING OF SAID PARTS

(71) Applicant: SAINT JEAN INDUSTRIES, Saint Jean D'ardieres (FR)

(72) Inventors: Emile Thomas DI SERIO, Chenas (FR); Lionel DUPERRAY, La Chapelle De Guinchay (FR); Frédéric PERRIER, Lyon (FR); Christophe DESRAYAUD, Lyon (FR)

(73) Assignee: SAINT JEAN INDUSTRIES, Saint Jean D'ardieres (FR)

(21) Appl. No.: 15/305,189

(22) PCT Filed: Apr. 22, 2015
(86) PCT No.: PCT/FR2015/051087

§ 371 Date: Oct. 19, 2016

(30) Foreign Application Priority Data
Apr. 29, 2014 (FR) 1453875

(51) Int. Cl. B22F 7/00; B22F 3/105; B22F 3/17; B22F 3/10; B22F 3/15; B33Y 80/00; B23K 26/342; B23K 26/00; B23K 15/00; B33Y 10/00; B33Y 40/00; B21J 5/02; B22F 3/24

(52) U.S. Cl. CPC B22F 7/008; B21J 5/025; B22F 3/1055; B22F 3/17; B22F 3/1017; B22F 3/15; B22F 3/24; B23K 26/342; B23K 26/0006; B23K 15/0086; B23K 15/0093; B33Y 10/00; B33Y 40/00; B33Y 80/00; B22F 2301/052; B22F 2301/205; B22F 2302/105; B22F 2302/253; B22F 2302/45; B22F 2998/10; B23K 2203/16

(57) ABSTRACT

A method of manufacturing a piece of metal alloy or of metal matrix composite materials includes making a preform by additive manufacturing by adding material in successive layers, and subjecting the preform to a forging operation taking place in a single step and between two dies with a view to obtaining the final shape of the piece.

The invention relates to the technical field of manufacturing pieces of metal or of metal matrix composite, particularly but non-limitingly for making components and equipment for the automobile and aviation sectors.

Additive manufacturing, which enables pieces or parts to be fabricated by fusing (melting together) or sintering successive layers, is developing, the basic concept being defined in Patent U.S. Pat. No. 4,575,330 dating from 1984.

Additive manufacturing is defined by ASTM as being a process of joining materials to make objects from three-dimensional (3D) model data, usually layer upon layer, as opposed to subtractive manufacturing methodologies such as machining, whereby material is removed. It is also the name given to the technology of 3D printing.

That technology has developed to make pieces of metal alloys either by fusing or sintering powder beds, or else by welding wires. Tests on metal matrix composites have shown themselves to be very promising. The technologies used, to mention them non-exhaustively, range from Selective Laser Sintering (SLS) to Electron Beam Melting (EBM) and include Direct Metal Laser Sintering (DMLS) and Laser Metal Deposition (LMD) or Selective Laser Melting (SLM). Those technologies make it possible to manufacture pieces or parts that are of high geometrical complexity and that have satisfactory mechanical properties, but that result comes at the price of a cycle time that is often lengthy. For each successive layer, the powder must be spread by a roller, and the electron beam or the laser must sweep the entire surface of each layer so as to obtain good cohesion of the powder. To reduce the cycle time, the strategy employed by manufacturers is to increase the power and the number of the beams so as to melt (fuse) or sinter each layer more rapidly, thereby increasing the cost of the manufacturing machine. The metals used are mainly titanium alloys for the EBM technology, but the technologies using laser are more versatile. They make it possible to manufacture pieces of ferrous alloys, of alloys based on titanium, aluminum, cobalt-chromium, nickel, etc., as well as of metal matrix composites (titanium-titanium carbide, aluminum-alumina, aluminum-silicon carbide, etc.).

Unfortunately, pieces or parts obtained by additive manufacturing quite often have residual microporosity. Such microporosity degrades the mechanical properties of the pieces or parts, in particular the ductility and fatigue strength. A Hot Isostatic Pressing (HIP) step, which consists in putting the piece under high pressure and at high temperature, is often necessary to obtain satisfactory fatigue strength.

Pieces or parts obtained by additive manufacturing also have surface roughness that is coarse due to the particle size of the powder used and to the residual trace of the various layers formed during the additive manufacturing.

Such pieces also have a casting microstructure due to the powder melting while the piece is being obtained or made. Such a structure is, in particular, lamellar for alloys based on titanium and does not make it possible to satisfy most specifications for structural aircraft parts. For improved mechanical properties, a bimodal microstructure that is both lamellar and nodular is required. Such a structure can then be obtained only by hot-deformation operations of the forging type, and under costly and specific implementation conditions.

In view of those drawbacks, the Applicant's approach was thus to think about and to find a solution making it possible to mitigate those various problems.

In entirely independent manner and without any relation to additive manufacturing, the Applicant has, since 1983, i.e. since a period corresponding to the that of the above-mentioned US patent, developed a novel concept combining casting and forging technologies for casting and forging a piece of aluminum or of aluminum alloy. That technology was disclosed in European Patent EP 119 365, and it implements a casting first phase for casting a piece of aluminum or of aluminum alloy in a mold so as to constitute a preform, the preform then being subjected to a forging operation in a die of smaller dimensions and making it possible to obtain the final shape to be obtained with very specific properties indicated in that patent. That “cast-and-forged” technology is sold under the trademark “COBAPRESS” that is now in widespread use globally.

Since that period 1983-1984, i.e. over the last thirty years, it has been observed that the solutions brought to remedy the above-recalled drawbacks suffered by additive manufacturing are lengthy and costly, and that no solution has been found for obtaining a bimodal microstructure, which is necessary in a large majority of structural aircraft parts that are made of titanium alloy.

Faced with the problems to be solved for additive manufacturing, the Applicant observed that the problem of microporosities that is encountered in such manufacturing is also present during manufacturing of castings.

The approach of the Applicant thus focused on seeking an unexpected combination of the two technologies constituted by additive manufacturing and by cast-and-forged technology, those two technologies being seemingly incompatible even though they have been known since the period 1983-1984.

In entirely unexpected manner, and on the basis of tests conducted by the Applicant, it has appeared that implementing a combination of the two technologies is capable of responding to and of remedying the drawbacks observed in additive manufacturing.

In accordance with the invention, the solution that has been developed consists in obtaining a piece of metal alloy or of metal matrix composite materials by additive manufacturing so as to form a preform, and then in forging said preform while it is hot, semi-hot, or cold, in a single step implemented between two dies with a view to obtaining the final shape for the piece to be obtained.

The resulting piece thus has its final shape, and, after deburring or without deburring, has the functional dimensions to be fit for purpose without requiring additional machining other than of the functional zones with limited tolerance ranges.

In entirely unexpected mariner, this method makes it possible to overcome the above-mentioned drawbacks and the limits observed with pieces obtained by additive manufacturing.

The forging step that consists in deforming the material makes it possible to reclose and to re-bond the microporosities with uniform boding of the various layers of the additive structure. This gives improved ductility and fatigue strength.

This step of forging between two polished dies also enables the surface roughness to be drastically reduced, thereby making it possible to improve the fatigue strength and the surface appearance.

The tests that have been conducted appear very promising. No indication of either of the technologies known since 1983-1984 could have suggested combining them because the state in which the preform was obtained was different, the preform being obtained by casting in the “cast-and-forged” technology, whereas it is obtained by fusing (melting together) or sintering successive layers in additive manufacturing.

In the context of implementing the invention, the piece may be a piece of metal alloy (based on steel, iron, aluminum, Inconel, nickel, titanium, chromium-cobalt, etc.) or of metal matrix composite materials (titanium-titanium carbide, aluminum-alumina, aluminum-silicon carbide, etc.).

The forging second step of the invention for forging the preform obtained by additive manufacturing may be performed hot, semi-hot, or cold. The dies may optionally be polished.

This technology of die forging a preform obtained by additive manufacturing may also be applied to preforms that have non-bonded or partially consolidated powder zones that are then deformed and bonded during the forging step. Forging powder preforms manufactured by uniaxial or isostatic compaction is already a known method. The technique used in the invention is novel in that the powder is held captive within the preform that has a bonded periphery. The fact that not all of the powder is bonded makes it possible to save a considerable amount of cycle time during the manufacturing. In order to sinter or melt the powder during additive manufacturing, the laser or the electron beam needs to sweep the entire surface of the piece for each layer. By performing the powder fusion optimally on the outside outline of the preform only, the preform thus being constituted by a solid bonded shell holding the partially consolidated or non-consolidated powder captive inside it, a preform is obtained that is in the form of a solid shell filled with non-bonded powder. Forging this preform makes it possible to obtain the end piece or part. Bonding the powder during the hot deformation is particularly effective on preforms manufactured by EBM due to such manufacturing taking place in a vacuum, which makes it possible to trap any gas inside the material.

This technique also offers the advantage of obtaining a microstructure having fine particles due to the fact that there is no fusion of the powder. Epitaxial growth of the particles on the lower layer has been observed during additive manufacturing of titanium alloy. Such growth gives rise to a microstructure with rather course particles, which is not good for the mechanical properties. With no fusion of the powder, the fineness of the microstructure is preserved. The non-bonded zones of the preform thus give zones with a very fine microstructure on the final piece or part because the bonding takes place in solid phase during the forging step. Such a fine structure that does not have any crystallographic texture is very good for the static and cyclic mechanical properties of the piece or part.

The above-highlighted advantages and unexpected results with implementing the invention constitute a considerable development in processing pieces of metal or of metal matrix composite that are obtained by additive manufacturing.

1- A method of manufacturing a piece of metal alloy or of metal matrix composite materials, comprising:
making a preform by additive manufacturing by adding material in successive layers; and
subjecting the preform to a forging operation taking place in a single step and between two dies with to obtain a final shape of the piece.

2- The method according to claim 1, wherein the piece of metal alloy comprises an alloy based on iron, aluminum, nickel, titanium, chromium, or cobalt.

3- The method according to claim 1, wherein the piece of composite materials comprises a titanium-titanium carbide alloy, an aluminum-alumina alloy, or an aluminum-silicon carbide alloy.

4- The method according to claim 1, wherein the forging operation is performed semi-hot or cold or hot.

5- The method according to claim 1, wherein the preform contains zones in which a powder is not bonded or is partially consolidated.

6- Pieces or parts obtained by implementing the method according to claim 1.
